(19) United States
(12) Patent Application Publication
(10) Pub. No.: US 2015/0088647 A1
(43) Pub. Date: Mar. 26, 2015

(54) METHOD FOR MERCHANT DISAMBIGUATION BASED ON RECEIPT DATA

(71) Applicant: fisoc, Inc., Austin, TX (US)

(72) Inventors: Daniel Edward Kim, Austin, TX (US); Jay P. Valanju, Austin, TX (US); Brian Rainey, Austin, TX (US); David H. Fruhling, II, Austin, TX (US)

(21) Appl. No.: 14/300,286

(22) Filed: Jun. 10, 2014

Related U.S. Application Data
(60) Provisional application No. 61/882,178, filed on Sep. 25, 2013.

(51) Int. Cl. G06Q 30/02

(52) U.S. Cl. CPC G06Q 30/0255
USPC 705/14.53

(57) ABSTRACT

A system for merchant disambiguation using receipt data accesses a receipt database and clusters the receipt information according to product characteristics. The system identifies merchant similarities according to the clustered receipt information, and an offer engine module generates competitive offers based on the merchant similarities.

### CROSS-REFERENCES TO RELATED APPLICATIONS

This application claims the benefit of U.S. Provisional Patent Application Ser. No. 61/882,178, filed Sep. 25, 2013, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to a merchant offer targeting system and, more particularly, to a system for merchant disambiguation using receipt data.

For merchant offer targeting systems, it is desirable to determine a true competitor of a merchant. SIC codes and NAIC codes do not offer the level of granularity needed to determine true competitive status on an item by item basis. For example, although conceptually, Target and Walmart are in the same industry, the actual items offered for sale do not line up. An example of this is furniture. An additional problem with category level merchant segmentation is merchants that offer a wide selection of goods and services. Merchant categorization and segmentation suffers from a taxonomy problem. Also, many times, in explicit categorization, self selection results in aspirational categorization.

### BRIEF SUMMARY OF THE INVENTION

A solution is to utilize explicit or implicit receipt level detail. In this manner, a competitor merchant can be identified that sells the same product, rather than a related product or a product of a different quality or class. The receipt data enables the system to ignore self-identified merchant categories and instead build a category of merchant based on the actual products sold by the merchant.

With appropriately identified competitor merchants, the information can be made available to an offer engine or the like to enact secondary actions such as pushing a competitive offer for other merchants in the same merchant category.

In an exemplary embodiment, a method for merchant disambiguation using receipt data includes the steps of (a) storing aggregated receipt information in a receipt database, where the receipt information includes an identification of a merchant, a product and a price of the product; (b) a processor clustering the receipt information according to product characteristics and identifying merchant similarities according to the clustered receipt information; and (c) an offer engine module generating competitive offers based on the merchant similarities. The receipt information may be extracted from a point of sale device or from a point of sale database, or the receipt information may be received directly from merchants or determined based on a merchant identification, store inventory, and product prices. Step (b) may be practiced by annotating the clustered receipt information with metadata that describes the cluster. In this context, the method may also include structuring the metadata based on product similarities rather than merchant types.

The method may include registering member merchants, where step (c) is practiced by generating competitive offers for customers of member merchants. In one embodiment, the receipt information includes customer identification information, and the method includes registering member customers and pushing the competitive offers to the member customers. The competitive offers may be pushed to the member customers based on a purchase profile of the member customers.

Step (b) may be practiced to build merchant categories based on products sold.

In another exemplary embodiment, a computer program is stored on a non-transitory computer medium for merchant disambiguation using receipt data. The computer program is executed by a processor to carry out the steps of the method.

In yet another exemplary embodiment, a computer system for merchant disambiguation using receipt data includes a processor, a receipt database, and an offer engine module. The receipt information includes an identification of a merchant, a product and a price of the product. The processor accesses the receipt database and clusters the receipt information according to product characteristics. The processor is programmed to identify merchant similarities according to the clustered receipt information. The offer engine module generates competitive offers based on the merchant similarities.

### BRIEF DESCRIPTION OF THE DRAWINGS

These and other aspects and advantages will be described in detail with reference to the accompanying drawings, in which:

FIG. 1 is a schematic diagram of the merchant offer targeting system according to preferred embodiments; and

FIG. 2 is a detailed schematic of a computer system.

### DETAILED DESCRIPTION OF THE INVENTION

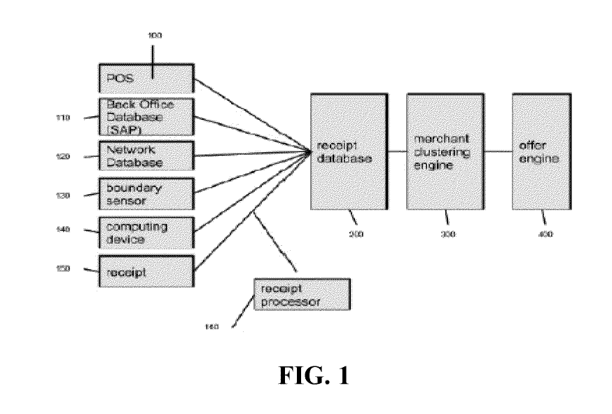

One solution for merchant disambiguation is to utilize explicit or implicit receipt level detail. The receipt information includes at least an identification of a merchant, a product and a price of the product. In some applications, the receipt information will also include purchaser information. With reference to FIG. 1, there are several ways of collecting this information including the point of sale (POS) 100 or an aggregated database of POS information 110, POS data stored on a network 120, RFID or some other wireless technology through a boundary 130, self identification through a device 140, or OCR (optical character recognition) or an identification key of the receipt itself 150. The information may also be provided by member merchants or purchased as mass POS integration data from a POS vendor. The contents of a receipt may be implicitly guessed at given store inventory and prices and computing possible solutions given total receipt amount by a specialized receipt processor 160.

Once the information is collected, the receipt level information is aggregated in a receipt database 200 along with the financial transaction. A merchant clustering engine 300 clusters and detects similarities between merchants. This information can be made available to an offer engine 400 to enact secondary actions such as pushing a competitive offer to other merchants in the cluster.

The merchant clustering engine 300 annotates the clusters with metadata that describes the cluster. The metadata may be structured based on product similarities rather than merchant types. As a result, competitor merchants can be identified that sell truly competitive products. The metadata enables the system to build categories of merchants based on products that they actually sell rather than a merchant's self-identified category. For example, a restaurant that does significant volume pushing tiramisu would be clustered against other restaurants providing that item, and the whole cluster would be marked as “tiramisu.” It would not be clustered with other restaurants identified as “Italian” because not all Italian restaurants necessarily serve tiramisu.

Of course, another benefit to the merchant clustering engine 300 is the ability to compute implied menus for restaurants. If the system is compiling POS level data, counts of what is and what isn't being sold can be measured. For example, it can be seen from a restaurant that there are a lot of orders for potstickers. The system can highlight that item as a “customer favorites.” The system can also compare this to other merchants who sell potstickers and create very tailored recommendations. Given two restaurants, where one is rated higher than the other on a general basis (e.g., on an online rating site). If the consumer is looking for the best potstickers (or a cuban sandwich or whatever), the system can back out review data from a customer who didn't order the potstickers and compute a correlation score based on potstickers so based on what the person wants to eat, we can compute the best reviews (and possibly the most relevant).

In an awards program, certain merchants may be registered as member merchants, where the offer engine module generates competitive offers for customers of the member merchants. In a similar context, member customers may be registered where the competitive offers are pushed to the member customers. In one embodiment, using known purchasing profile technology, the competitive offers are pushed to the member customers based on a purchase profile/history of the member customers.

Using receipt level detail and receipt information, merchant disambiguation can be achieved for an effective merchant offer targeting system.

The merchant disambiguation process described with reference to FIG. 1 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:
the transfer protocol (e.g., http://); and
the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the merchant disambiguation system of the present invention include Mozilla Firefox® and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

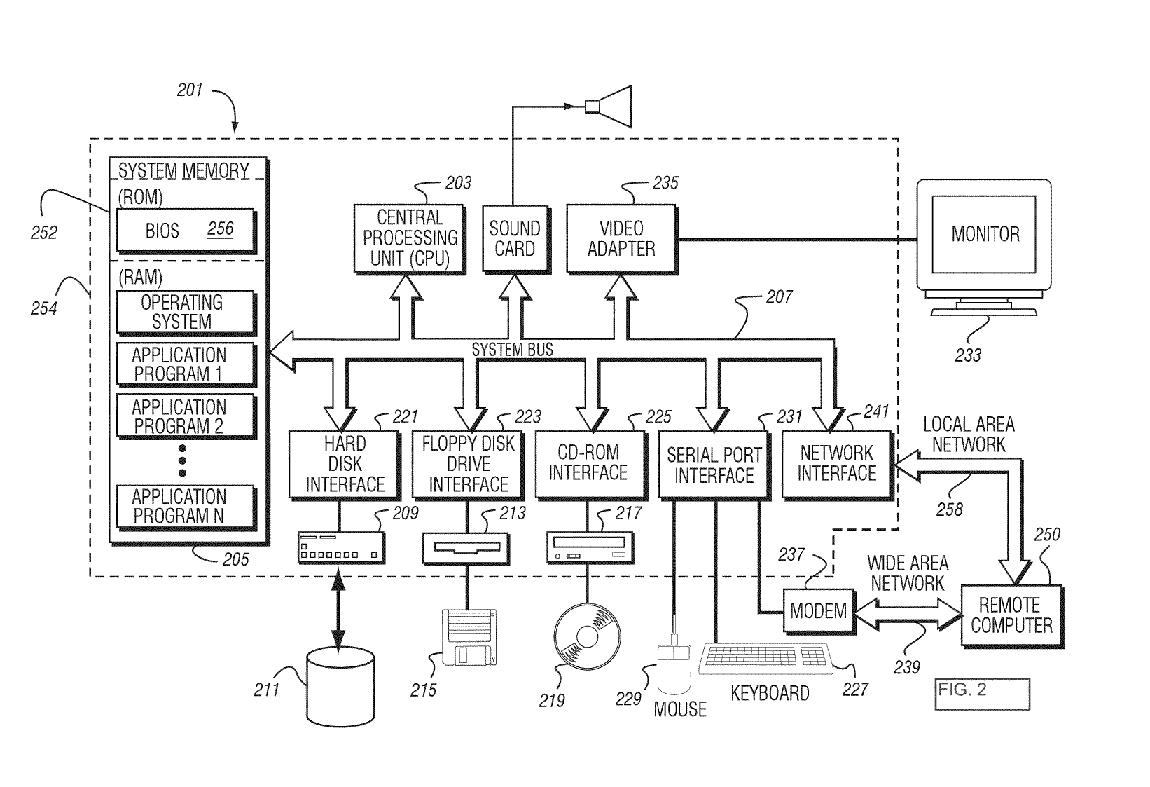

FIG. 2 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method for merchant disambiguation using receipt data, the method comprising:
(a) storing aggregated receipt information in a receipt database, the receipt information including an identification of a merchant, a product and a price of the product;
(b) a processor clustering the receipt information according to product characteristics and identifying merchant similarities according to the clustered receipt information; and
(c) an offer engine module generating competitive offers based on the merchant similarities.

2. A method according to claim 1, further comprising, prior to step (a), extracting the receipt information from a point of sale device.

3. A method according to claim 1, further comprising, prior to step (a), extracting the receipt information from a point of sale database.

4. A method according to claim 1, further comprising, prior to step (a), receiving the receipt information directly from merchants.

5. A method according to claim 1, further comprising, prior to step (a), the processor determining the receipt information based on a merchant identification, store inventory, and product prices.

6. A method according to claim 1, wherein step (b) is practiced by annotating the clustered receipt information with metadata that describes the cluster.

7. A method according to claim 6, comprising structuring the metadata based on product similarities rather than merchant types.

8. A method according to claim 1, further comprising registering member merchants, wherein step (c) is practiced by generating competitive offers for customers of member merchants.

9. A method according to claim 1, wherein the receipt information includes customer identification information, the method further comprising registering member customers and pushing the competitive offers to the member customers.

10. A method according to claim 9, wherein the competitive offers are pushed to the member customers based on a purchase profile of the member customers.

11. A method according to claim 1, wherein step (b) is practiced to build merchant categories based on products sold.

12. A computer program stored on a non-transitory computer medium for merchant disambiguation using receipt data, the computer program being executed by a processor to carry out the steps of:
(a) storing aggregated receipt information in a receipt database, the receipt information including an identification of a merchant, a product and a price of the product;
(b) clustering the receipt information according to product characteristics and identifying merchant similarities according to the clustered receipt information; and
(c) generating competitive offers based on the merchant similarities.

13. A computer program according to claim 12, wherein step (b) is practiced by annotating the clustered receipt information with metadata that describes the cluster.

14. A computer program according to claim 13, wherein the computer program is further executed to structure the metadata based on product similarities rather than merchant types.

15. A computer system for merchant disambiguation using receipt data, the computer system comprising:
a processor;
a receipt database storing aggregated receipt information, the receipt information including an identification of a merchant, a product and a price of the product, wherein the processor accesses the receipt database and clusters the receipt information according to product characteristics, the processor being programmed to identify merchant similarities according to the clustered receipt information; and
an offer engine module generating competitive offers based on the merchant similarities.

16. A computer system according to claim 15, further comprising metadata tags for annotating the clustered receipt information, the metadata tags describing the cluster.

17. A computer program according to claim 16, wherein the metadata is structured based on product similarities rather than merchant types.
